(19) United States
(12) Patent Application Publication
(10) Pub. No.: US 2008/0022579 A1
(43) Pub. Date: Jan. 31, 2008

(54) Weight-forward fishing sinker for use in a bait projectile and apparatus and method for making such projectile

(75) Inventors: Douglas J. Osenbach, New Ringgold, PA (US); Daniel Triano, New Ringgold, PA (US)

Correspondence Address: JOHN F. LETCHFORD, ARCHER & GREINER, P.C., ONE CENENNIAL SQUARE, HADDONFIELD, NJ, 08033, US

(73) Assignee: Far Out Fishin, LLC, New Ringgold, PA (US)

(21) Appl. No.: 11/881,207

(22) Filed: Jul. 26, 2007

Related U.S. Application Data
(60) Provisional application No. 60/820,361, filed on Jul. 26, 2006.

(51) Int. Cl. A01K 95/00; A01K 91/02

(52) U.S. Cl. 43/43.1; 43/41

(57) ABSTRACT

A weight or sinker adapted to be received within a bait projectile formation canister, a projectile including the weight and associated fishing tackle and bait/lure(s), and an apparatus and method for making the projectile. The sinker is preferably shaped to be substantially matingly received within canister, which canister preferably assumes the shape of a ballistic projectile. The preferred shape of the sinker is substantially that of the tip of a ballistic projectile. Following insertion of the sinker into the canister, water is poured into the canister to engulf any bait and hooks, bait, lures and/or floats that may be attached to the sinker. The canister is then placed into a freezer to unite the sinker and any attached fishing tackle and bait into a unitary ballistic projectile.

### CROSS REFERENCE TO RELATED APPLICATION(S)

This application is related to U.S. patent application Ser. No. 11/229,993, filed Sep. 19, 2005, entitled “Fishing Line Casting and Bait Projectile System”, the disclosure of which is incorporated herein in its entirety, and claims the benefit of U.S. Provisional Patent Application No. 60/820,361, filed Jul. 26, 2006, which is incorporated herein by reference in its entirety.

### FIELD OF THE INVENTION

The present invention relates to the fishing line casting art and, more particularly, to a projectile to which fishing line to be cast is attached, which projectile is cast by a powered fishing line casting system for safely and reliably casting bait to a target area located a distance that could not be reached with conventional casting methods.

### BACKGROUND OF THE INVENTION

The sport of fishing is practiced and enjoyed by a large percentage of the population. Many of those who engage in this sport practice that form of fishing known as casting. These fishermen cast from docks, from wharves, from boats, and into the surf, to state but a few examples. It is necessary in casting to have a sufficiently clear working area to facilitate rod, line, and terminal tackle movement. The movement which is made during casting is very dangerous in that the sinker and fishhook describe a launch path from the rear of the fisherman's location and when launched may hit or hook objects or persons that are within the launch path. Thus, most casting methods are ineffective in confined quarters and impose on the fisherman certain restrictive body postures.

Casting methods demand an acquired skill level, hand-eye coordination, timing, etc., to produce consistently accurate results in the placement of the terminal tackle. Casting ability depends on the manner of execution, which in turn depends on a fisherman's skill, physical power and dexterity. The purpose of casting is, of course, to obtain the exact placement of the line in order to increase the probability of success. Such often requires casting bait to distances remote from the location of the fisherman. This is particularly so with respect to surf fishing where a fisherman casting from a beach is required to have considerable skill and accuracy in the placement of the bait in a selected target area in deep water. Often in these circumstances, it is desired to make a cast further than can normally be made by conventional manual casting techniques. This problem is exacerbated in the case of elderly or handicapped individuals whose strength and/or physical dexterity may be compromised.

As a result, various arrangements have been developed for providing a powered casting system. Such arrangements have utilized a variety of bait propulsion systems such as springs, compressed gases and other propellants. Examples of which are provided in U.S. patent application Ser. No. 11/229,993, as well as U.S. Pat. Nos. 2,977,706; 3,279,115; 3,400,480; 3,416,256; 3,419,991; 3,834,056; 4,110,929; 4,631,852; 4,756,113; 5,060,413 and 5,689,909. However, since the details of suitable means for launching a bait projectile are not essential for a proper understanding of the present invention they are neither described in detail nor claimed herein.

A significant physical aspect affecting the launching efficiency and accuracy of a bait projectile, or any projectile for that matter, is the aerodynamics of the projectile itself. None of the foregoing fishing bait launching systems disclose or suggest a bait launching system in which all weights, floats, hooks, lures, and artificial and natural bait products and/or other constituents are contained within a streamlined object or projectile that experiences minimal air or frictional resistance from launch until it reaches its desired target area. Consequently, existing fishing bait launching systems launch bait with less accuracy and to less distance than may be otherwise attainable.

An advantage exists therefore, for a fishing line bait projectile for use in powered casting systems that is an entirely streamlined and aerodynamic object that experiences minimal air or frictional resistance throughout the entire launch process.

A further advantage exists for an apparatus for making such a fishing line bait projectile.

A further advantage exists for a method for making such a fishing line bait projectile.

A further advantage exists for a fishing line weight or sinker that forms a leading part or nose of such a fishing line bait projectile.

### SUMMARY OF THE INVENTION

The present invention provides a strategically-weighted and streamlined projectile to which fishing line to be cast is attached, which projectile is cast by a powered fishing line casting system for safely and reliably casting bait to a remote target area. More particularly, the invention involves a weight or sinker that is adapted to be received within a bait projectile formation canister such as that disclosed in the aforementioned U.S. patent application Ser. No. 11/229,993. The sinker is preferably formed of a heavy, dense material having a density considerably greater than water such as metal and is preferably shaped to be substantially matingly received within the bait projectile formation canister. The bait projectile formation canister preferably assumes the shape of a ballistic projectile such as a bullet, mortar or the like. Hence, the preferred shape of the sinker is that of the tip of a ballistic projectile.

At its rearward or posterior end the sinker includes an eyelet or similar fishing line or fishing leader attachment means. Bait and casting leaders are attached to the eyelet and the completed assembly is inserted, sinker first, into the bait projectile formation canister. Water is poured into the bait projectile formation canister to engulf the bait and casting leaders and any hooks, bait, lures and/or floats attached to the casting leader. The canister is then placed into a freezer to unite the sinker and leader assembly into a ballistic projectile shaped unit suitable for launching by a bait casting system such as that disclosed in U.S. patent application Ser. No. 11/229,993. The incorporation of the sinker into the projectile has demonstrated enhanced launching distance and accuracy of the fishing line that is to be cast.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a side elevation view of a bait projectile formation canister constructed in accordance with the present invention;

FIG. 2 is a side elevation view of a fishing line sinker constructed in accordance with the present invention; and

FIG. 3 is an elevational cross-section view of a bait projectile formation canister within which is a fishing line sinker according to the present invention disposed beneath a mass of frozen water whereby the sinker and frozen water form a unitary, aerodynamic projectile.

### DETAILED DESCRIPTION OF THE INVENTION

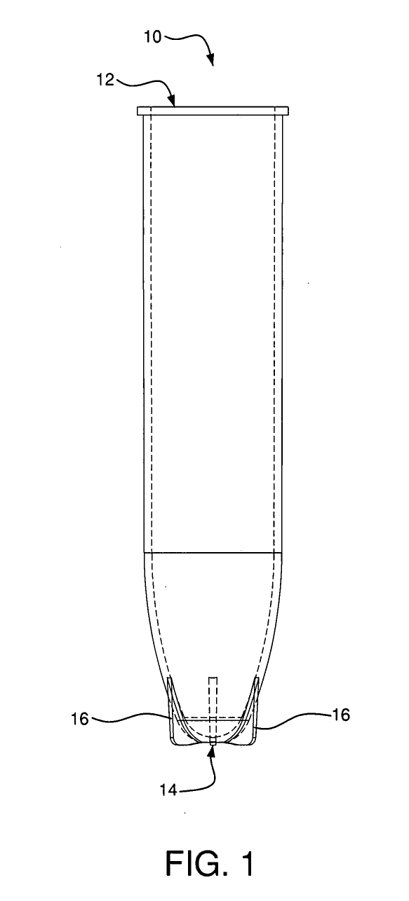

Referring to the drawings wherein like or similar references indicate like or similar elements throughout the several views, there is shown in FIG. 1 a bait projectile forming canister constructed according to the present invention, identified generally by reference numeral 10. Canister 10 is preferably formed from a durable and moderately flexible plastic material such as high density polyethylene (“HDPE”) or the like. The body of canister 10 is generally cylindrical in shape and has an open first end 12 and a closed second end 14. As described in greater detail below, an assembly comprising a fishing weight or sinker and one or more of a float, leader(s), hook(s), and natural and/or artificial bait or lure(s) is inserted into the open end 12 of canister 10 and lowered until it comes to rest in the bottom of the canister and the casting leader projects from the canister's open end 12. Some or all of the remaining volume of the canister is then filled with water. The canister is thereafter refrigerated until the water is frozen thereby producing a solid projectile in which the fishing tackle, bait and/or lure(s) are enveloped and which is suitable for launching through the barrel of a powered fishing line casting system such as, for example, that described in U.S. patent application Ser. No. 11/229,993.

Canister 10 is preferably tapered toward the closed second end 14 whereby the canister assumes the shape of a ballistic projectile. Hence, the preferred shape of the sinker, described below, is that of the tip of a ballistic projectile. The advantages from such a canister shape are two-fold. First, it assists in dislodging the frozen projectile from the canister (which dislodgement is further facilitated if the canister is fabricated from a flexible/resilient material). Second, the tapered end of the frozen projectile is the forward or leading end of the projectile when it is launched from a launch tube or barrel of a powered fishing line casting system. The tapered leading end imparts to the projectile a streamlined, aerodynamic shape similar to the outer configuration of a bullet, missile, rocket or similar ballistic projectile thereby enabling the projectile to efficiently pass through the atmosphere upon launch. According to a presently preferred, although non-limitative, embodiment of the present invention, the frozen projectile has a diameter preferably slightly less than the inside diameter of the bait launch tube described in U.S. patent application Ser. No. 11/229,993 and a length generally ranging from about 4 to about 16 inches, more preferably about 8-10 inches. It will be understood, however, that the frozen projectile may assume any size and shape to be accommodated by the launch tube of any suitable powered fishing line casting system.

In general, it has been found that a typical projectile formed in accordance with the present invention will weigh on the order of about 8 to 30 ounces, or even greater. Lighter weight projectiles may be utilized with a fishing line that typically may be on the order of 60 pound test fishing line. The heavier weight projectiles will require heavier tensile strength fishing lines. That is, the projectile according to the invention may be of any suitable design or weight, according to the wishes of the user and the type of fish intended to be caught. The only consideration is that the design of the projectile be such that it will fit loosely in the launch tube of a powered fishing line casting system so that there is little frictional resistance and, thus, will be easily launched.

Canister 10 desirably includes support means 16 for maintaining the canister in an upright position so that water does not spill from the canister during freezing. Support means 16 may be releasably or permanently attached to canister 10. Preferably, support means 16 are constructed in the form of a plurality, typically at least three, integral and radially arranged gussets or vanes equiangularly disposed at the outer surface of closed end 14.

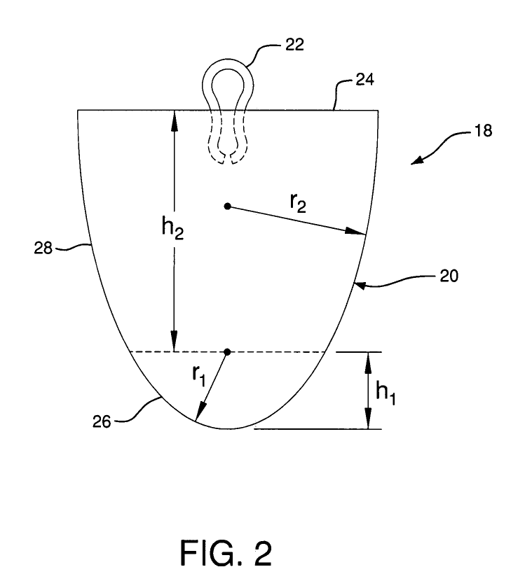

FIG. 2 depicts a representative fishing line weight or sinker according to the present invention, identified generally by reference numeral 18. Sinker 18 is preferably formed from a dense, heavy material having a density considerably greater than water such as, for example, lead, steel, stainless steel or other metal or metal alloy by casting molding or other suitable known techniques. The circumferential surface 20 of the sinker preferably assumes the general shape of the tip of a ballistic projectile such as bullet, mortar or the like. An eyelet 22 or similar fishing line or leader attachment means is carried at a rear or posterior surface 24 of sinker 18. The eyelet may be fabricated from the same material as and formed integrally with the body of the sinker itself, or it may be a separate member embedded in the sinker (as illustrated) or otherwise securely attached to the rear surface 24.

Circumferential surface 20 may be defined by one or more sub-surfaces selected from the family of geometrical shapes known as conic sub-surfaces (including without limitation, conical, elliptical, parabolic and hyperbolic sub-surfaces), as well as spherical sub-surfaces and/or cylindrical sub-surfaces.

The sinker desirably has a weight suitable to provide appropriate aerodynamic stability during launch and ballistic trajectory of the projectile, as well as suitable anchoring of the hook(s), lure(s), bait, float(s) and the like upon contact with the bottom surface of a body of water after the launch is completed.

According to a presently preferred embodiment, sinker 18 is adapted to be substantially matingly received within the closed second end 14 of canister 10. By way of example but not limitation, circumferential surface 20 may include a first tip sub-surface 26 contiguous with a second wall sub-surface 28. In the illustrated example, tip sub-surface 26 may be a spherical surface having a height “h₁” of approximately 0.50″ and a radius “r₁” of approximately 0.50″, and wall sub-surface 28 may be a spherical surface having a height “h₂” of approximately 1.00″ and a radius “r₂” of approximately 7.00″. Using lead as the sinker material, the resultant sinker weighs approximately 10-12 ounces. However, it will be understood that sinkers according to the present invention may be made from various materials, may assume various shapes and sizes and may weigh from about 6 to about 30 ounces in order to achieve the desired effects of improved fishing line casting distance and accuracy.

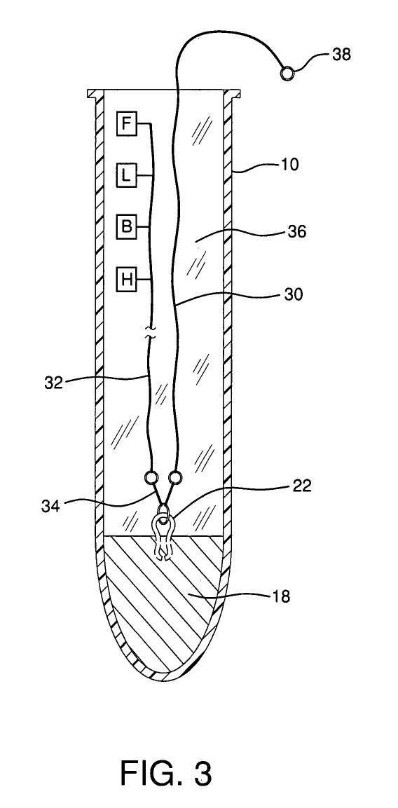

Referring to FIG. 3, in forming a launchable bait projectile, a casting leader 30 may be directly attached to the eyelet 22. Alternatively, the casting leader may be attached to the eyelet by any suitable means, such as a swivel. Also attached to the eyelet is a separate bait leader, only partially shown for clarity of illustration by reference numeral 32, to which may be attached any combination of hook(s), bait(s) lure(s), and float(s), generically identified by references, “H”, “B”, “L” and “F”, respectively. Preferably, although not necessarily, a three-way swivel 34 secures both the casting leader 30 and the bait leader 32 to the eyelet 22. The completed assembly is then inserted, sinker first, into bait projectile formation canister 10. Water is then poured into the canister. The filled canister is then frozen whereby the ice positively engages the sinker via the eyelet 22 to form a unitary bait projectile. The resultant bait projectile thus includes sinker 18 and a frozen mass of water 36 above the sinker that surrounds the casting and bait leaders and any lures, baits, hooks and floats attached to the bait leader. The frozen bait projectile is then separated from the bait projectile formation canister 10 and attached at a free end 38 of casting leader 30 to an unillustrated fishing rod fishing line whereby it may be launched by a fishing line casting system such as that disclosed in U.S. patent application Ser. No. 11/229,993. The present inventors have discovered that the presence of the sinker at the tip of the frozen bait projectile provides concentrated forward weight to the tip of the bait projectile that increases the distance and accuracy of the cast.

Bait leader 32 may comprise a braided a metal-coated fishing line, but is not limited thereto. The bait leader is preferably wound around the float (if present, or other fishing tackle or bait/lures if it is not) in a proper manner such that, as the frozen water of the projectile thaws in the body of water into which it is cast, the bait leader begins to easily unwind.

When the cast projectile lands in the water, the weight of the sinker 20 incorporated into the projectile drags the casting leader 30 down while the unillustrated fishing line unwinds from a fishing reel allowing the projectile to sink into the body of water. When the frozen water component 36 of the projectile thaws, the float (if present) is set free in the water. The bait leader 32 unwinds from the float and the float, along with the hook(s), bait and/or lure(s), rises upwardly from sinker 18 for the length of the bait leader 32 until the bait leader assumes a substantially upright position within the body of water. If the float is not present, a generally similar scenario unfolds. Because of the incorporation of the fishing tackle and bait into a unitary projectile, the accelerating forces to which the bait is subjected during launch are typically not sufficient to cause stripping of the bait from the hooks when the bait is frozen.

The above descriptions of various types of projectiles that may be utilized in the present invention are merely illustrative of a few of the many variations that may be produced according to the present invention. The position, shape, form, color and materials used in the projectile may vary greatly depending on conditions and the desired species of fish being sought. It will be understood that extremes from highly visible (brightly colored attractant) to near invisible (transparent), floating to sinking, and erratic to non-erratic retrieval action will be desired under different conditions, and can be obtained by using a wide variety of shapes, patterns, colors, densities and materials without departing from the inventive concept herein disclosed.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A fishing sinker for use as the tip of a frozen bait projectile, said sinker comprising:
a circumferential surface generally having the shape of the tip of a ballistic projectile;
a rear surface; and
an eyelet adjacent said rear surface adapted for attachment to at least one of a fishing line and a fishing leader.

2. The sinker of claim 1 wherein said circumferential surface comprises at least one conic sub-surface.

3. The sinker of claim 1 wherein said circumferential surface is configured to be substantially matingly received within a bait projectile formation canister.

4. The sinker of claim 1 further comprising at least one of a casting leader and a bait leader connected to said eyelet.

5. The sinker of claim 4 further comprising at least one swivel for connecting said at least one of a casting leader and a bait leader to said eyelet.

6. A fishing line bait projectile comprising:
a sinker having an eyelet; and
a mass of frozen water connected to said sinker and within which is contained at least one of a hook, a lure, bait and a float connected to said eyelet.

7. The fishing line bait projectile of claim 6 wherein said sinker includes:
a circumferential surface generally having the shape of the tip of a ballistic projectile; and
a rear surface, wherein said eyelet is disposed adjacent said rear surface.

8. The fishing line bait projectile of claim 6 further comprising at least one of a casting leader and a bait leader connected to said eyelet.

9. The fishing line bait projectile of claim 8 further comprising at least one swivel for connecting said at least one of a casting leader and a bait leader to said eyelet.

10. The fishing line bait projectile of claim 6 wherein said sinker is disposed at a tip of said projectile.

11. The fishing line bait projectile of claim 6 wherein said projectile is in the general shape of a ballistic projectile.

12. Apparatus for making a fishing line bait projectile comprising:
a canister having an open first end and a closed second end; and
a sinker adapted for substantial mating reception within said second end of said canister and having an eyelet adapted for attachment to at least one of a fishing line and a fishing leader, wherein, upon insertion of said sinker into said canister, water may be poured into said canister and frozen.

13. The apparatus of claim 12 wherein said canister is tapered toward said second end whereby said canister assumes the shape of a ballistic projectile.

14. The apparatus of claim 13 wherein said sinker has a circumferential surface generally having the shape of the tip of a ballistic projectile.

15. The apparatus of claim 12 wherein said canister is formed from flexible material.

16. A method for making a fishing line bait projectile comprising the steps of:
(a) selecting a canister having an open first end and a closed second end;
(b) inserting a sinker into said canister, said sinker having an eyelet connected to at least one of a fishing line and a fishing leader, said at least one of a fishing line and a fishing leader being connected to at least one of a hook, a lure, bait and a float;
(c) pouring water into said canister, and
(d) cooling said water and canister until the water is frozen.

17. The method of claim 16 wherein said canister is tapered toward said second end whereby said canister assumes the shape of a ballistic projectile.

18. The apparatus of claim 17 wherein said sinker has a circumferential surface generally having the shape of the tip of a ballistic projectile.
